(19) United States
(12) Patent Application Publication
(10) Pub. No.: US 2014/0239722 A1
(43) Pub. Date: Aug. 28, 2014

(54) PHOTOVOLTAIC POWER GENERATION SYSTEM, CONTROL METHOD AND CONTROL PROGRAM FOR PHOTOVOLTAIC POWER GENERATION SYSTEM

(71) Applicant: Kabushiki Kaisha Toshiba, Tokyo (JP)

(72) Inventors: Kazuto Arai, Tokyo (JP); Takeshi Niimoto, Kawasaki-shi (JP)

(73) Assignee: Kabushiki Kaisha Toshiba, Tokyo (JP)

(21) Appl. No.: 14/177,661

(22) Filed: Feb. 11, 2014

(30) Foreign Application Priority Data
Feb. 22, 2013 (JP) 2013-033896

(51) Int. Cl. H02J 9/06

(52) U.S. Cl. CPC H02J 9/061
USPC 307/52; 307/43

(57) ABSTRACT

A photovoltaic power generation system includes a photovoltaic power generator including a plurality of PV modules, and a PV inverter that connects an output by the photovoltaic power generator to a power grid. The ratio of a rated output by the photovoltaic power generator defined by a rated output by the PV modules relative to a rated output by the PV inverter is equal to or greater than 140%. The photovoltaic power generation system further includes a battery unit, a battery inverter that connects an output by the battery unit to a power grid, and a controller that adjusts an output by the battery unit in such a way that an output by the battery inverter becomes equal to or greater than a preset electric power together with an output by the PV inverter.

### CROSS-REFERENCE TO RELATED APPLICATIONS

This application is based upon and claims the benefit of priority from Japan Patent Application No. 2013-033896, filed on Feb. 22, 2013, the entire contents of which are incorporated herein by reference.

### BACKGROUND OF THE INVENTION

1. Field of the Invention

The present disclosure relates to a photovoltaic(PV) power generation system including a PV module and a PV inverter, and a control method and a control program for the PV power generation system.

2. Description of the Related Art

PV power generation systems are configured to obtain desired power by connecting an output by a PV module to a device called a PV inverter (PCS). In general, such PV power generation systems include multiple PV strings connected in series relative to the PV module and connected in parallel with the PV inverter.

The PV inverter has an inverter function for a connection with a power grid. The inverter function converts DC power output by the PV module into AC power, and outputs the converted AC power to the power grid.

According to general PV power generation systems, the number of PV modules is designed in such a way that the rated output by the PV inverter and the total value of the rated outputs by the PV modules become substantially equal to each other.

In addition, recently, construction of large-scale PV power generation systems called a mega solar which exceeds 1 MW is advancing by utilizing a large amount of PV modules. Thus, the facility capacity of the PV power generation system connected with a power grid is increasing, and thus the applicability of the PV power generation system as a power source compensating a power demand is expected.

For example, there is a correlation between a power demand in summertime and the amount of generated power by the PV power generation system. That is, during a time slot at which a temperature and a power demand for air conditioners are high, the amount of solar radiation becomes high, and thus the large amount of generated power by the PV modules can be ensured. This is a remarkable difference in comparison with, for example, wind power generation.

Hence, it is desirable if power from the PV power generation system can be counted as the availability to a power demand in a system operation plan during a time period that is a time slot at which the power demand and the amount of solar radiation are high.

However, the output by the PV power generation system is likely to be affected by weather, and is unstable in comparison with the output by conventional power generation facilities. Accordingly, it is often difficult to count the availability of the PV power generation system as a stable power source relative to a demand to a power grid connected with the PV power generation system.

That is, in a planning of a system operation, in order to count on the power generation capacity of a given power source, it is necessary that power of equal to or greater than certain level can be obtained stably for a certain time period. It is difficult to count a power source in an operation plan which is capable of supplying power at a given time but which frequently becomes unable to supply power at another given time within a short time period.

For example, in a high solar radiation time between 11:00 to 14:00 with solar radiation of approximately 800 W/m², when the amount of solar radiation changes due to shadow, etc., the output fluctuation of the PV power generation system becomes large. In this case, in a power grid connected with the PV power generation system, the power demand and the power supply become unbalanced, and thus it becomes sometimes difficult to maintain a frequency at constant.

The present disclosure has been made in order to address the above-explained technical problems of conventional technologies, and it is an objective of the present disclosure to provide a PV power generation system that can be counted on as a stable power availability to a power grid, and can suppress a output fluctuation.

### SUMMARY OF THE INVENTION

To accomplish the above objective, an aspect of the present disclosure provides a PV power generation system that includes: a PV power generator including a plurality of PV modules; and a PV inverter that connects an output by the PV power generator to a power grid, in which a ratio of a rated output by the PV power generator defined by a rated output by the PV modules relative to a rated output by the PV inverter is equal to or greater than 140%.

Other aspects of the present disclosure can be realized in the forms of a method of causing a computer or an electronic circuit to execute the above-explained functions, and a program that causes a computer to execute the above-explained functions.

### BRIEF DESCRIPTION OF THE DRAWINGS

FIG. 1 is a schematic configuration diagram illustrating a PV power generation system according to a first embodiment;

FIG. 2 is an explanatory diagram illustrating a correlation between a power demand and a PV power generation output when an inverter over sizing factor is 100%;

FIG. 3 is an explanatory diagram illustrating a correlation between a power demand and a PV power generation output when an inverter over sizing factor is 140%;

FIG. 4 is an explanatory diagram illustrating a relationship between an inverter over sizing factor and a PV power generation availability;

FIG. 5 is a schematic configuration diagram illustrating a PV power generation system according to a second embodiment;

FIG. 6 is an explanatory diagram illustrating a relationship among an inverter over sizing factor, a PV power generation availability, and an output by a battery;

FIG. 7 is an explanatory diagram illustrating a P (power)-V (voltage) curve of a PV power generator; and

FIG. 8 is an explanatory diagram illustrating a PV power generation output curve of a day when an output fluctuation is suppressed.

### DETAILED DESCRIPTION OF THE PREFERRED EMBODIMENTS

### A. First Embodiment

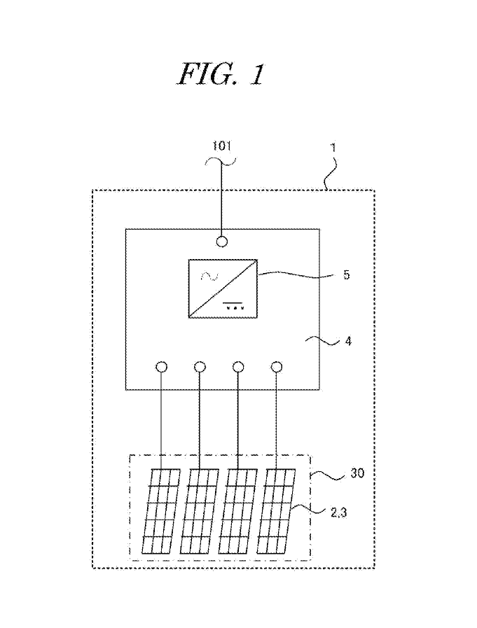

A photovoltaic(PV) power generation system of this embodiment will be explained with reference to FIGS. 1 to 4.

[1. Configuration]

[1-1. Basic Configuration]

A photovoltaic(PV) power generation system 1 of this embodiment includes PV strings 3, and a PV inverter 4. The PV strings 3 have multiple PV modules 2 connected in series. The multiple PV strings 3 are connected in parallel with the PV inverter 4. In the following explanation, the multiple PV strings 3 connected with the PV inverter 4 will be collectively referred to as a PV power generator 30.

The PV inverter 4 is connected between the PV strings 3 and a power grid 101, and connects the PV strings 3 to the power grid 101. The PV inverter 4 includes an inverter 5. The inverter 5 is a converter that converts DC power output by the PV power generator 30 into AC power with a predetermined frequency. An example predetermined frequency is a commercial power frequency when the power grid 101 is a commercial power system.

In addition, the PV inverter 4 has a Maximum Power Point Tracking (MPPT) control function, a power system protection function for interconnection, and an automatic disconnection function, etc. The MPPT control function controls the operating point of an output defined by a current and a voltage so as to be always maximum in accordance with the output fluctuation of a PV. The power system protection function for interconnection detects an abnormality at the system side and at the inverter side, and terminates the inverter function. The automatic disconnection function temporarily terminates the operation when the output by the PV becomes low, such as sundown, and rain, and the output by the PV inverter becomes substantially zero.

[1-2. Setting of PV Power Generator]

The rated output by the PV power generator 30 connected to the PV inverter 4 is set to be equal to or greater than 140% relative to the rated output by the PV inverter 4. The rated output by the PV power generator 30 is defined by the rated output by the PV modules 2 or the PV strings 3.

The rated output by the PV modules 2 is a value obtained by measuring power output under a condition called a reference state. The reference state is, for example, a condition in which the surface temperature of the PV module 2 is 25° C., a spectral radiant distribution AM is 1.5, and a solar radiation intensity is 1000 W/m². The AM is an atmosphere mass that solar light passes through until reaching the ground.

The rated output by the PV strings 3 is defined by the rated output by the connected PV modules 2. The rated output by the PV power generator 30 is defined by the number of connected PV strings 3. For example, the rated output by the PV power generator 30 is defined by a total of the operating currents and a product of operating voltages of the respective PV strings 3 at the time of a rated output.

Based on the above-explained facts, in this embodiment, the rated output and number of the PV modules 2 to be utilized, and the number of the PV strings 3 to be connected, etc., are selected in such a way that the rated output by the PV power generator 30 becomes equal to or greater than 140% relative to the rated output by the PV inverter 4.

[2. Operation and Advantages]

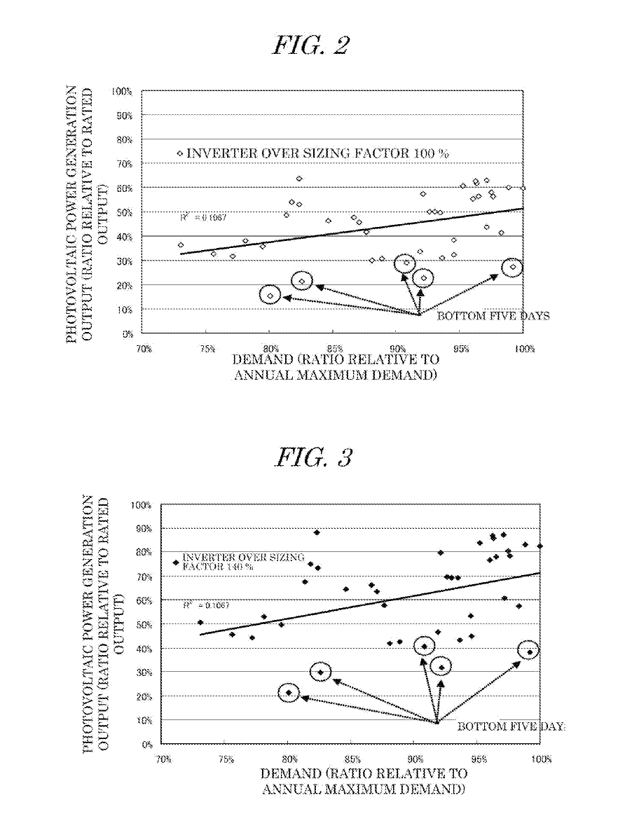

The operation and advantages of this embodiment explained above will be explained with reference to FIGS. 2 to 4. In the following explanation, a ratio of the rated output by the PV power generator 30 relative to the rated output by the PV inverter 4 will be simply and collectively referred to as an inverter over sizing factor.

First, the DC power generated by the PV power generator 30 is output to the PV inverter 4. Then the DC power is converted into AC power through the inverter 5, and is supplied to an unillustrated load facility connected to the power grid 101. Accordingly, the PV power generation system 1 is connected to the power grid 101.

As explained above, there is a correlation between a power demand and a solar radiation amount in summertime. Summertime means a time period from July to September in Japan. For example, it is expected that the PV modules 2 generate constant output during a time period in summertime from 14:00 to 17:00 at which a power demand is high. The reason to expect the demand in summertime is that the power demand in summertime is the highest in a year, and it is highly necessary to compensate the power generation capacity of conventional power generation facilities, etc., with natural energy of PV, etc.

FIGS. 2 and 3 are diagrams illustrating example correlations between a power demand and an output by the PV power generation system 1 in summertime. FIG. 2 is a scattering diagram indicating data of several days when the inverter over sizing factor is 100% with whitened rectangles. FIG. 3 is a scattering diagram indicating data of several days when the inverter over sizing factor is 140% with blacked rectangles. Note that a regression line and a correlation coefficient are indicated in FIGS. 2 and 3.

In FIGS. 2 and 3, the horizontal axis indicates a ratio of a demand for each day relative to a demand at a day when the power demand becomes the maximum in a year. More specifically, the horizontal axis indicates a ratio obtained by dividing, by the maximum demand in this year, the maximum demand at a day when the power demand from 14:00 to 17:00 becomes maximum other than Saturday, Sunday, holidays, and a period for a vacation in summer.

In addition, in FIGS. 2 and 3, the vertical axis indicates a ratio of the output by the PV power generation system 1 relative to the rated output by the PV inverter 4. More specifically, the vertical axis indicates a ratio of an output by the PV power generation system 1 at a time slot at which the maximum demand occurs for each day, calculated based on the weather data by AMeDAS, Automated Meteorological Data Acquisition System, relative to the rated output by the PV inverter 4.

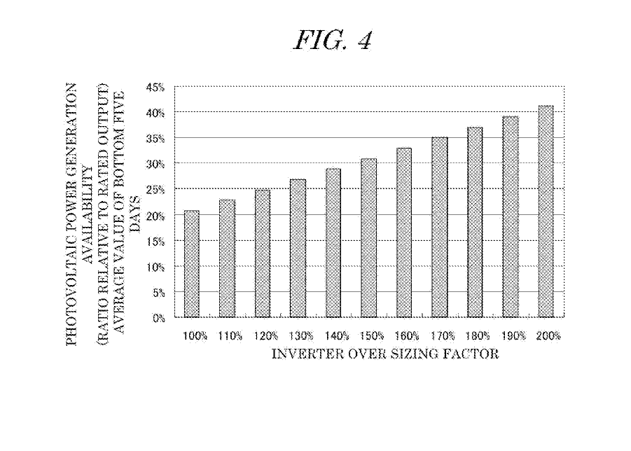

FIG. 4 is a diagram illustrating the availability of the PV power generation system 1 at an inverter over sizing factor of 100 to 200%. The horizontal axis of FIG. 4 indicates the inverter over sizing factor for every 10%. The vertical axis indicates, with respect to the ratio (availability) of the output by the PV power generation system 1 relative to the rated output by the PV inverter 4, an average value of bottom five days in a year.

In order to count the PV power generation that has unstable output on the system operation, it is necessary to evaluate the power that can be at least stably ensured as the availability. Hence, in FIG. 4, the availability is obtained using the average of bottom five days at which the PV power generation output is low. For example, the average value of the bottom five days in FIG. 2 corresponds to the availability in FIG. 4 when the inverter over sizing factor is 100%. In addition, the average value of the bottom five days in FIG. 3 corresponds to the availability in FIG. 4 when the inverter over sizing factor is 140%.

It is desirable that high output should be stably obtained from the PV power generation system 1 when a power demand is high, for example during daytime. Accordingly, FIGS. 2 to 4 illustrate whether or not the output by the PV power generation system 1 can be incorporated as a stable generated output in an operation plan to a power demand.

That is, when the inverter over sizing factor of the general PV power generation system 1 is 100%, as illustrated in FIG. 4, the availability of only 20% relative to the rated output by the PV inverter 4 can be expected at the maximum demand. The availability of such a level is insufficient to be considered as a stable power source.

Conversely, according to the PV power generation system 1 of this embodiment, the inverter over sizing factor is set to be 140%. In this case, as illustrated in FIG. 4, the availability of 30% relative to the rated output by the PV inverter 4 can be expected at the maximum demand. When the availability of such a level is obtainable, it can be incorporated in the operation plan as a stable power source.

According to a general thought, the total of the rated output by the PV power generation is set so as to match the rated output by the PV inverter 4. That is, the rated output by the PV power generator 30 is set so as to obtain the rated output by the PV inverter 4 when the power generation level from the PV modules becomes the maximum.

When the rated output by the PV power generator 30 is set to be larger than the rated output by the PV inverter 4, such a setting is made in consideration of the loss of power. That is, power reaching the PV inverter 4 from the PV modules 2 has a loss of 3 to 10% or so. Hence, in order to compensate such a loss, the rated output by the PV power generator 30 is set to be larger than the rated output by the PV inverter 4 in some cases.

In contrast, according to this embodiment, the inverter over sizing factor is purposefully set to be equal to or greater than 140% which is far beyond the setting of compensating such a loss. Hence, according to this embodiment, a stable availability can be counted on relative to the demand for the power grid 101 connected with the PV power generation system 1. In particular, it can be expected as a fixed output power source within a time slot at which solar irradiation is stable. Therefore, the ratio of the power originating from renewable energy in power supplied to the power demand can be increased.

In addition, when the output by the PV power generator 30 is low, the PV inverter 4 terminates the operation. Accordingly, when the rated output by the PV power generator 30 is substantially equivalent to the rated output by the PV inverter 4, the availability ratio is low. According to this embodiment, however, since the inverter over sizing factor is set to be equal to or greater than 140%, the possibility of operation termination is reduced, while at the same time, the availability ratio of the PV inverter 4 is increased. Therefore, this embodiment needs less costs in comparison with cases in which the number of the PV inverters 4 and the capacity thereof are increased with costs, but increases an output to be obtained.

Still further, the output fluctuation from the PV power generation system 1 affects the output frequency fluctuation, but when the inverter over sizing factor is set to be 140% to stabilize the output, the output frequency becomes also stable. Therefore, the output by the PV power generation system 1 less affects the system frequency.

Note that the time slot at which power demand is high differs based on the area where the PV power generation system is located. Hence number of PV modules can be modified according to the area where the system is located. For example, by setting the inverter over sizing factor so as to achieve the electric power required at the power grid of the location area with the intensive solar radiation like 800 W/m², the PV power generation system can be counted on as stable power availability to the power grid.

### B. Second Embodiment

[1. Configuration]

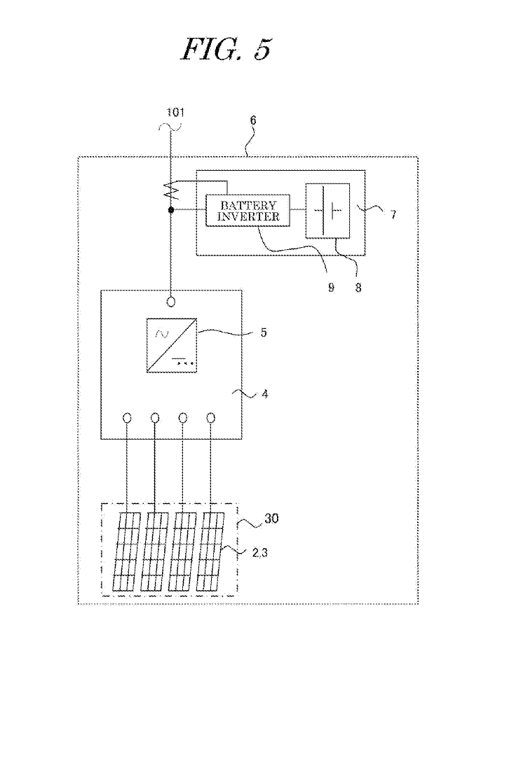

Next, an explanation will be given of a second embodiment with reference to FIGS. 5 and 6. The same configuration as that of the first embodiment will be denoted by the same reference numeral, and the duplicated explanation thereof will be omitted.

As illustrated in FIG. 5, this embodiment is constructed as a battery-equipped PV power generation system 6. That is, a battery system 7 is added to the AC system end of the PV power generation system 1 indicated in the first embodiment.

The battery system 7 includes a battery 8, and a battery inverter 9. A secondary battery that can perform charging and discharging may be used as the battery 8. For example, a lead battery, a lithium-ion battery, nickel and hydrogen batteries are applicable as the battery 8.

The battery inverter 9 converts the power output by the battery 8 into AC power with a predetermined frequency, and outputs the AC power to the power grid 101. When, for example, the power grid 101 is a commercial power system, the predetermined frequency is set to be a commercial power frequency. In addition, the battery inverter 9 includes an unillustrated controller. This controller has a function of controlling an output from the battery 8 to the power grid 101. That is, the controller controls the output power from the battery inverter 9 based on measurement information obtained by measuring a power or a current to the power grid 101 through an unillustrated measuring unit.

The measuring unit is not limited to any particular one as long as it receives an input from the PV inverter 4. The measurement location can be any location between the PV inverter 4 and the power grid 101, and is not limited to any particular location.

The controller is set with a reverse power flow allowed to flow through the power grid 101 in accordance with a preset time or a power demand. Accordingly, when determining that the output by the PV inverter 4 is less than the reverse power flow set in advance, the controller outputs a power which corresponds to a difference between the set reverse power flow and the output by the PV inverter 4. Hence, the battery 8 is selected so as to have a capacity that is equal to or greater than a capacity that can output a power which corresponds to a difference between the set reverse power flow and the output by the PV inverter 4.

[2. Operation and Advantages]

The operation and advantages of the above-explained embodiment will be explained with reference to FIG. 6. The following explanation will be given of an example case in which a desired availability is counted from the battery-equipped PV power generation system 6 with respect to a demand in summertime. FIG. 6 is a diagram illustrating examples of the availability of the battery-equipped PV power generation system 6 at each inverter over sizing factor illustrated in FIG. 4 and the output by the battery system 7.

When, for example, it is desirable to set 30% of the rated output by the PV inverter 4 to be the availability of the battery-equipped PV power generation system 6, the reverse power flow set in advance is indicated as a dashed line P in FIG. 6.

The controller in the battery inverter 9 compensates the shortfall power up to the dashed line P by the output from the battery 8 when the output by the battery-equipped PV power generation system 6 is smaller than the dashed line P. In this case, as indicated in the above-explained first embodiment, when the inverter over sizing factor is 140%, the availability of the battery-equipped PV power generation system 6 becomes close to 30% of the rated output. Hence, when the set reverse flow power is set to be this 30%, power that must be output by the battery 8 can be low.

According to the above-explained embodiment, a desired availability can be further stably obtained by the battery-equipped PV power generation system 6. Still further, the availability from the battery-equipped PV power generation system 6 can be expected at a high level that is equal to or greater than 140%, and the capacity of the battery 8 additionally placed can be minimized.

The output by the battery 8 can be increased so as to obtain a stable output beyond 30% of the rated output by the PV inverter 4. Accordingly, it can be counted as a further stable output that is equal to or greater than 30% on the system operation.

### C. Third Embodiment

[1. Configuration]

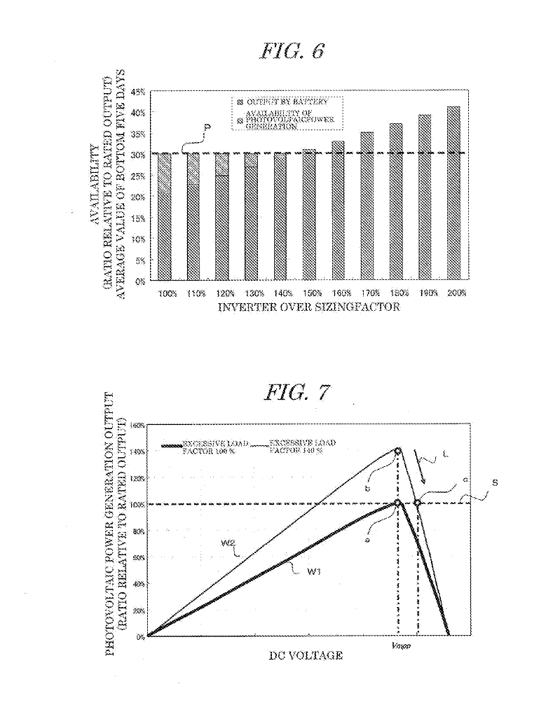

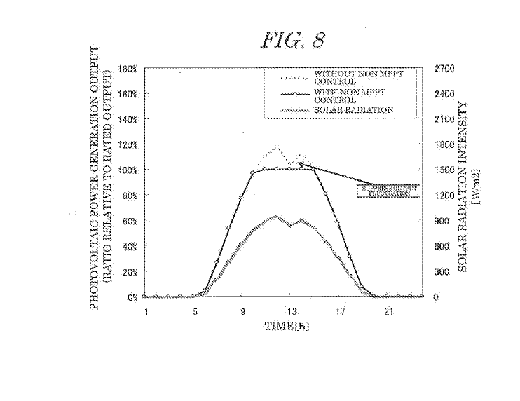

Next, an explanation will be given of a third embodiment with reference to FIGS. 7 and 8. Note that the same configuration as that of the first embodiment will be denoted by the same reference numeral, and the duplicated explanation will be omitted.

As explained above, the PV inverter 4 includes an MPPT control function. That is, since the output by the PV power generator 30 changes in accordance with a solar irradiation intensity and the surface temperature of the PV module 2, the operating point is changed so as to track the maximum output point, thereby obtaining the maximum power.

The MPPT control is, more specifically, carried out by the controller of the PV inverter 4 as follows upon monitoring the current and the voltage. First, the controller slightly changes a DC operating voltage or a DC current, or, both DC operating voltage and DC current for each predetermined time cycle.

The controller compares the output power by the PV power generator 30 at this time and the stored value of the previous output power. Next, the controller changes the DC operating voltage of the PV inverter 4 or the DC current, or, both DC operating voltage and DC current so as to always set the output power by the PV power generator 30 greater than the stored value.

However, the MPPT control is performed when the input DC current or the output AC current is equal to or smaller than a preset current value in the controller. Conversely, when the DC current or the AC current exceeds the preset current value, the controller restricts a current to be output, thereby terminating the MPPT control. Next, the controller excludes the operating point of the PV power generator 30 from the maximum power point to perform a non MPPT control, and outputs power at the rated output value of the PV inverter 4.

An explanation will be given of a non MPPT control of the PV inverter 4 with reference to FIG. 7 based on a current-voltage characteristic of the PV power generator 30 and a power-voltage characteristic thereof. The vertical axis of FIG. 7 indicates a ratio of the PV power generator 30 relative to the rated output by the PV inverter 4. The horizontal axis of FIG. 7 indicates a DC voltage of the PV power generator 30. A curved line W1 indicates an example case in which the inverter over sizing factor is 100%, and a curved line W2 indicates an example case in which the inverter over sizing factor is 140%.

As illustrated in this FIG. 7, the PV power generator 30 has a characteristic indicated by the curved line W1 that is the output-DC voltage characteristic of the PV power generator 30 when the inverter over sizing factor is 100% at the rated output. In addition, the PV power generator 30 has a characteristic indicated by the curved line W2 that is the output-DC voltage characteristic of the PV power generator 30 when the inverter over sizing factor is 140% at the rated output.

In this case, when the predetermined current value is set to be a current value of an AC current at the time of the rated output by the PV inverter 4, the output by the predetermined current value becomes the rated output by the PV inverter 4 as indicated by a dashed line S in FIG. 7.

When, for example, the solar radiation intensity in daylight hours becomes 1000 W/m², if the inverter over sizing factor is 100%, the PV power generator 30 operates in accordance with the curved line W1, and the output by the PV power generator 30 is adjusted by an optimized operating voltage Vmpp at a point a in the curved line W1.

Conversely, when the inverter over sizing factor is 140%, the PV power generator 30 operates in accordance with the curved line W2 to output power. At this time, when the MPPT control on the PV inverter 4 is continued, the operating point of the PV power generator 30 is directed to a maximum output point b, and exceeds a rated output S by the PV inverter 4. Hence, the current value exceeds the predetermined current value.

In such a case, the controller of the PV inverter 4 performs a non MPPT control. That is, when the output current of the PV power generator 30 is located above a dashed line S in the curved line W2, the controller performs a control indicated by a thick arrow L to change the operating point of the PV power generator 30 to a point c of the curved line W2 by increasing the operating voltage, thereby reducing the current value to be less than the predetermined current value.

The non MPPT control by the PV inverter 4 adjusts the operating point of the PV power generator 30 to be always near the maximum output point c by continuing the above-explained control. The controller of the PV inverter 4 cancels the non MPPT control, and restarts the MPPT control after a predetermined time has elapsed or after the output is reduced to an appropriate level.

[2. Operation and Advantages]

An explanation will be given of an operation of the above-explained embodiment and the advantages thereof. First, FIG. 8 is a diagram illustrating a power generation output curve of the PV power generation system 1 at a sunny day and at an inverter over sizing factor of 140% with the current value at the time of the rated output by the PV inverter 4 being set as a preset current value. The vertical axis of FIG. 8 indicates a ratio of the output by the PV power generation system 1 relative to the rated output by the PV inverter 4. The horizontal axis of FIG. 8 indicates a time in a day.

When the solar radiation is intensive, if the PV power generation output exceeds the rated output by the PV inverter 4, as explained above, the output by the PV inverter 4 is fixed to the rated output value. Hence, the PV power generation system 1 becomes a constant current outputting power source from 11:00 to 14:00. In addition, even when a solar radiation fluctuation occurs during a time period between 11:00 to 14:00, if the solar radiation exceeds 800 W/m², the output by the PV inverter 4 does not reflect the output fluctuation.

As explained above, according to this embodiment, an output fluctuation by the PV power generation due to a solar radiation fluctuation is suppressed at the time of intensive solar radiation like 800 W/m² during 11:00 to 14:00, and the output by the PV inverter 4 becomes constant. Hence, it becomes possible to maintain the balancing of the demand for power of the system connected with the PV power generation system 1 and the supply therefrom.

In addition, through the non MPPT control by the controller of the PV inverter 4, the operating point of the PV power generator 30 is adjusted, and the output current by the PV power generator 30 can be suppressed to a current value that is equal to or smaller than a preset current value. By increasing the operating voltage through the non MPPT control, the DC current becomes small. This suppresses the output by the PV power generator 30, thereby preventing the PV inverter 4 from becoming an excessive load operation condition. Still further, it becomes possible to suppress a wastage and a deterioration of the PV power generator 30 and other devices.

### D. Other Embodiments

The present disclosure is not limited to the above-explained embodiments. For example, the second embodiment and the third embodiment may be combined together. The respective numbers of the PV modules 2 and the PV strings 3 and the respective connection configurations are not limited to any particular numbers and connection configurations as long as a rated output by the PV power generator 30 that corresponds to the present disclosure is obtainable. For example, instead of the PV strings 3, individual PV modules 2 are electrically connected in parallel with each other to configure the PV power generator 30.

It is fine if the ratio of the rated output by the PV power generator 30 relative to the rated output by the PV inverter 4 be equal to or greater than 140%. That is, as indicated in the third embodiment, no matter how the output by the PV power generator 30 increases, theoretically, it can be suppressed to the rated output by the PV inverter 4. However, in consideration of a suppression of an excessive current input, it can be set to, for example, 140 to 200%.

In addition, the number of PV inverters 4 may be one or a multiple number. The system connected with the PV inverter 4 is not limited to the commercial power grid 101. For example, a stable availability for a demand in an establishment in summertime can be expected if the PV inverter is connected with a system connected with a general household power source.

The battery 8 utilized for the battery system 7 can be inexpensively constructed by, for example, capacitors or electric double layer capacitors. In addition, according to the above embodiments, the battery system 7 is connected to the system through the battery inverter 9, but a configuration can be constructed in which a DC current from the PV power generator 30 is charged, and discharging power is output to the system through the PV inverter 4 or the battery inverter 9.

All of or some of the controllers of the PV inverter 4, the inverter 5, and the battery inverter 9 can be realized by a computer that includes a CPU and is controlled by a predetermined program. In this case, such a program physically utilizes the hardware resources of the computer to realize the above-explained processes. Hence, a method and a program for executing the above-explained processes, and a recording medium having stored therein the program are also embodiments of the present disclosure.

Still further, how to set the range processed by the hardware resources, and the range processed by a software including the program is not limited to any particular ranges. For example, any of the above-explained components may be realized by a circuit that executes each process.

The controller includes a memory device like a memory that stores various settings explained above. This memory device includes a register, a memory, etc., utilized as a temporal memory area. Hence, a memory area can be regarded as the memory device even if such a memory area temporally stores information for each process explained above.

The specific detail of information utilized in the above-explained embodiments, and the value can be freely changed without departing from the scope and spirit of the present disclosure. In the above-explained embodiments, it is optional in a large/small determination with respect to a threshold and a consistency/inconsistency determination, etc., as to whether a subjected value is determined as being included which is equal to or greater than or equal to or smaller than, or is determined as being excluded which is larger than, above, exceeding, smaller than, below, or underneath.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A photovoltaic power generation system comprising:
a photovoltaic power generator including a plurality of PV modules; and
a PV inverter that connects an output by the photovoltaic power generator to a power grid,
wherein a ratio of a rated output by the photovoltaic power generator defined by a rated output by the PV modules relative to a rated output by the PV inverter is equal to or greater than 140%.

2. The photovoltaic power generation system according to claim 1, further comprising:
a battery unit;
a battery inverter that connects an output by the battery unit to the power grid; and
a controller that adjusts the output by the battery unit in such a way that an output by the battery inverter together with an output by the PV inverter becomes equal to or greater than a preset electric power.

3. The photovoltaic power generation system according to claim 2, wherein the electric power is equal to or greater than 30% of the rated output by the PV inverter.

4. The photovoltaic power generation system according to any one of claims 1 to 3, wherein:
the PV inverter comprises a controller that performs a maximum power point tracking control; and
when a current value at the PV inverter becomes equal to or greater than a preset value, the controller of the PV inverter terminates the maximum power point tracking control to make the output by the PV inverter constant.

5. The photovoltaic power generation system according to claim 4, wherein the constant output is the rated output by the PV inverter.

6. A control method for a photovoltaic power generation system, wherein:
the photovoltaic power generation system comprises:
a photovoltaic power generator including a plurality of PV modules;
a PV inverter that connects an output by the photovoltaic power generator to a power grid;
a battery unit; and
a battery inverter that connects an output by the battery unit to a power grid;
a ratio of a rated output by the photovoltaic power generator defined by a rated output by the PV modules relative to a rated output by the PV inverter is equal to or greater than 140%; and
the method causes a computer or an electronic circuit to adjust the output by the battery unit in such a way that an output by the battery inverter becomes equal to or greater than a preset electric power together with an output by the PV inverter.

7. A control method for a photovoltaic power generation system, wherein:
the photovoltaic power generation system comprises:
a photovoltaic power generator including a plurality of PV modules; and
a PV inverter that connects an output by the photovoltaic power generator to a power grid;
a ratio of a rated output by the photovoltaic power generator defined by a rated output by the PV modules relative to a rated output by the PV inverter is equal to or greater than 140%;
the PV inverter performs a maximum power point tracking control; and
the method causes a computer or an electronic circuit to terminate the maximum power point tracking control to make an output by the PV inverter constant when a current at the PV inverter becomes equal to or greater than a preset value.

8. A computer readable non-transitory recording medium having stored therein a control program that controls a photovoltaic power generation system that causes a computer to execute:
the photovoltaic power generation system comprises:
a photovoltaic power generator including a plurality of PV modules;
a PV inverter that connects an output by the photovoltaic power generator to a power grid;
a battery unit; and
a battery inverter that connects an output by the battery unit to a power grid;
a ratio of a rated output by the photovoltaic power generator defined by a rated output by the PV modules relative to a rated output by the PV inverter is equal to or greater than 140%; and
the control program causes a computer to adjust the output by the battery unit in such a way that an output by the battery inverter becomes equal to or greater than a preset electric power together with an output by the PV inverter.

9. A computer readable non-transitory recording medium having stored therein a control program that controls a photovoltaic power generation system that causes a computer to execute:
the photovoltaic power generation system comprises:
a photovoltaic power generator including a plurality of PV modules; and
a PV inverter that connects an output by the photovoltaic power generator to a power grid;
a ratio of a rated output by the photovoltaic power generator defined by a rated output by the PV modules relative to a rated output by the PV inverter is equal to or greater than 140%;
the PV inverter performs a maximum power point tracking control; and
the control program causes a computer to terminate the maximum power point tracking control to make an output by the PV inverter constant when a current at the PV inverter becomes equal to or greater than a preset value.

10. The photovoltaic power generation system according to claim 1, wherein the PV inverter is configured to supply more electric power than the rated output by the photovoltaic power generator when a power demand is high during daytime.
